(19) United States
(12) Patent Application Publication
(10) Pub. No.: US 2013/0121498 A1
(43) Pub. Date: May 16, 2013

(54) NOISE REDUCTION USING MICROPHONE ARRAY ORIENTATION INFORMATION

(71) Applicant: David Giesbrecht, Toronto (CA)

(72) Inventor: David Giesbrecht, Toronto (CA)

(73) Assignee: QSound Labs, Inc.

(21) Appl. No.: 13/294,176

(22) Filed: Nov. 11, 2011

(51) Int. Cl. H04B 3/20; H04R 3/00

(52) U.S. Cl. 381/66; 381/92

(57) ABSTRACT

A handheld device includes: an orientation sensor; an audio processor connected to the orientation sensor and adapted to receive orientation information from the orientation sensor; and a plurality of microphones through which audio content is captured, wherein the audio processor modifies the noise reduction algorithm applied to the audio content captured based, at least in part, on the orientation information.

### BACKGROUND OF THE INVENTION

The present subject matter provides a mobile and/or handheld audio system including two or more acoustic sensors and an orientation sensor, wherein the orientation information is used to optimize the performance of noise reduction algorithms used to capture an audio source.

Many mobile devices, including smartphones and tablet computers, may be used in varying orientations with respect to a user. In fact, due to the mobility of such devices, it is often possible to have a wide range of operable positions, beyond the simple portrait versus landscape orientation.

The mobile devices often include two or more microphones or other acoustic sensors for capturing sounds for use in various applications. For example, such systems are used in speakerphones, video VOIP, voice recognition applications, audio/video recording, etc. The performance of the microphones is typically improved using one or more beamforming noise reduction algorithms for noise cancellation. Generally speaking, beamformers use weighting and time-delay algorithms to combine the signals from the various microphones into a single signal. An adaptive post-filter is typically applied to the combined signal to further improve noise suppression and audio quality of the captured signal.

In traditional implementations, the target user (the audio source) is assumed to be in a constant and consistent location with respect to the device and, more specifically, with respect to the acoustic sensors. In such cases, the beamformer is typically configured to have a fixed “look” (i.e., target) direction within which the algorithm may present fixed or adaptive noise cancellation functionality. A fixed beamformer will typically have a fixed location within which the noise cancellation is optimized (i.e., a fixed polar pattern). These systems and methods fall short when the device is a mobile and/or handheld device because the user's orientation in respect to the device may change, sometimes frequently, including mid-use. Due to the fixed beamformer look direction, noise reduction performance (and hence voice quality) can be significantly affected by the device's orientation.

One possible solution is to augment the performance of the system using an adaptive beamformer algorithm incorporating beam steering. An adaptive beamformer may provide some algorithmic functions for steering the optimal zone of noise cancelation within a given range of locations, typically along a chosen direction. However, such adaptive beamformers are very processor and memory intensive, especially when using in conjunction with other voice processing algorithms such as acoustic echo cancellation, which additionally taxes the battery life of the device.

Accordingly, there is a need for an efficient and effective system and method for improving the noise reduction performance of microphone arrays in mobile devices, as described and claimed herein.

### SUMMARY OF THE INVENTION

In order to meet these needs and others, the present invention provides a system and method in which an orientation sensor is used to improve noise reduction performance in microphone arrays in a mobile and/or handheld audio system.

In one example, a mobile handheld audio system includes two or more microphones and an orientation sensor, the output of which is used to choose a fixed beamformer look direction from a plurality of directions. Providing a device with the ability to switch between look directions for a fixed beamformer algorithm improves the noise reduction performance of the device without significantly diminishing the processor, memory and battery performance of the device.

In a primary example, the mobile handheld audio system includes a pair of microphones used to capture audio content. An audio processor receives the captured audio signals from the microphones. An orientation sensor (e.g., accelerometer, gyroscope, compass, position sensor, etc.) provides an orientation signal to the audio processor, which uses the orientation signal to select an optimal preset configuration for the noise reduction algorithm to improve noise reduction in the signal by reducing background noise with minimal suppression or distortion of the target audio source (e.g., the user's voice). Accordingly, as the handheld device changes orientation, the orientation sensor provides a signal to the processor, which adapts a beamformer algorithm to correspond to the devices orientation.

For example, in one embodiment using a two microphone array, depending on the device's orientation, the target beamformer look direction may be selected from one of several preset angles from 0 to 180 degrees with respect to the mic-to-mic axis.

It is contemplated that one advantageous use of the solutions provided herein is in “far-talk” voice applications (e.g., mobile speakerphone, video phone, voice recognition, etc.) where both the source audio (e.g., user's voice) and the primary noise sources are located relatively far from the device compared to the inter-mic distance. For example, in a typical multi-mic mobile phone or tablet computer, the inter-mic distance may be approximately five inches or less, whereas the user's mouth may be a more than one foot away from the microphones and the ambient noise to be suppressed may be even further away. In far-talk applications, all of the audio sources (target sources and noise sources) can be considered to be in the acoustic far-field of the microphone array, and thus will exhibit approximately equal signal amplitudes at each microphone. By contrast, “close-talk” beamforming algorithms (e.g., used during regular phone handset operation or Bluetooth headset configurations) behave differently. Instead of focusing beams or nulls in a given direction, close-talk beamformers may exploit the so-called “Precedence Effect,” wherein the target voice source is located in array's near-field. Therefore, the voice signal will be louder on one microphone than the other, whereas unwanted noise sources are in the array's far-field and will have approximately equal signal amplitudes at each microphone.

While there are numerous forms of far-talk beamforming algorithms, any of which may be adapted to work with the solutions provided herein, two representative examples are provided. The first is the use of a fixed beamformer and adaptive post-filter. The second example is the use of an adaptive beamformer and adaptive post-filter.

In the first example, a fixed multi-microphone beamformer is used (e.g., delay-sum, filter-sum) to process the audio signals received from the microphones. A fixed look direction is chosen from a set of presets depending on the output of the orientation sensor. An adaptive post-filter follows the selected multi-microphone beamformer for additional noise suppression. Traditionally, such a post-filter employs both temporal info (for tracking stationary noise) as well as inter-microphone spatial info (for tracking directional and/or non-stationary noise) with a Wiener-type filtering operation. Both the beamformer and the post-filter algorithms can be implemented in either the time or frequency domain, as desired.

In the second example, an adaptive multi- microphone beamformer is used (e.g., generalized side-lobe canceller, GSC) to process the audio signals received from the microphones. As above, a fixed look direction is chosen from a set of presets. In addition, the beamformer's nulls are adaptively steered to optimally cancel any directional or moving noise sources (e.g., using LMS-type filter adaptation). Again, an adaptive post-filter follows the beamformer for additional noise suppression. Both the beamformer and post-filter algorithms can be implemented in either the time or frequency domain, as desired.

The control and adaption of the noise reduction algorithms by the audio processor may be subject to one or more stabilization algorithms that prevent overcorrection or detrimental jumping between beamformer algorithms. For example, the audio processor may require a minimum change in orientation angle or may require a minimum duration of orientation shift before the noise reduction algorithm is modified in response to the orientation change. Further, the audio processor may use a running average of the last N positions as a basis for position information or utilize other known data smoothing techniques.

There are numerous elements that may function as an orientation sensor. Illustrative examples include: GPS receivers, compasses, accelerometers, position sensors, inertial sensor, etc. While not commonly incorporated into current handheld devices, it is understood that sensors based on radar, sonar or the like may be used to acquire further orientation and/or location information that may be used to orient the beamformer's look direction. In one embodiment featuring a mobile device with a tri-axial accelerometer, the accelerometer's x,y,z signals are sampled (e.g., at a rate of 50 Hz). These signals can then be low-pass filtered and analyzed to determine the dominant direction of the accelerometer's DC component to extract the direction of gravity in either Cartesian or spherical co-ordinates. For example, using x,y,z axes, a device lying flat on a table top will exhibit a dominant gravity direction along the x-axis.

As described, when using an adaptive beamformer configuration, the orientation information may be used to automatically change the beamformer look direction. However, when the device's orientation is changed, the beamformer must also re-adapt its nulls to ensure directional noise sources continue to be optimally cancelled. Therefore, the adaptive beamformer may also use the device's orientation information to automatically steer the beamformer's nulls. For a GSC beamformer implementation this may include, but is not limited to, using the device's orientation information to automatically adjust the GSC's blocking matrix as well as its adaptive filter coefficients.

In each of the examples provided, an adaptive post-filter is used for further multi-microphone noise suppression. Traditionally, these post-filters use inter-microphone spatial information and would benefit from knowing when the device's orientation has changed. Accordingly, the input orientation sensor information may be used to adjust the adaptive post-filter performance, as well as the beamformer.

In many instances, the mobile and/or handheld device will be positioned in a manner such that a specific beamformer direction may be optimal. For example, it may be possible to determine the most likely position of the user and select a beamformed (fixed or adaptive) directed towards the user. However, if the device is used while lying flat on a tabletop (the device's orientation will be approximately perpendicular to the direction of gravity), it may not be obvious to use orientation info to determine the location of the user. In fact, in this situation there may be several simultaneous users, such as placing a smartphone on a table during a conference call involving multiple people. In this flat orientation, it may be advantageous for the beamformer to use choose a preset with a more wide or “inclusive” beam to ensure good voice quality from multiple locations simultaneously. Accordingly, it is understood that the orientation information may be used to select the appropriate noise reduction algorithm (or set of algorithms), not merely select the direction of a given beamformer algorithm.

In instances in which the device is used for telephony communication, for example in speakerphone, VOIP or video-phone applications, multi-microphone noise reduction is usually combined with an acoustic echo canceller algorithm to remove speaker-to-microphone feedback. When using a beamformer algorithm, the acoustic echo canceller algorithm is typically implemented after the beamformer to save on processor and memory allocation (if placed before the beamformer algorithm, a separate acoustic echo canceller algorithm is typically implemented for each mic channel). If the beamformer look direction is changed in the second step, it would be advantageous for the acoustic echo canceller algorithm to also be adjusted to ensure optimal echo cancellation.

In one example, a handheld device includes: an orientation sensor; an audio processor connected to the orientation sensor and adapted to receive orientation information from the orientation sensor; and a plurality of acoustic sensors through which audio content is captured, wherein the audio processor selects and applies one or more noise reduction algorithms to the captured audio content based, at least in part, on the orientation information. The one or more noise reduction algorithms may include a beamformer algorithm. The beamformer algorithm may be a fixed beamformer algorithm or an adaptive beamformer algorithm. The beamformer algorithm may receive, as an input, data from the orientation sensor. The beamformer may be selected from a group of beamformer configurations including a wide-beam beamformer configuration. The one or more noise reduction algorithms may further include an adaptive post-filter. The adaptive post-filter may receive, as an input, data from the orientation sensor. The one or more noise reduction algorithms may include an acoustic echo canceler algorithm. The acoustic echo canceler algorithm may receive, as an input, data from the beamformer.

In one example, a method of using an orientation sensor to select and control one or more noise suppression algorithms applied to audio content captured from a pair of microphones in a device including an orientation sensor and audio processor, the method includes the steps of: receiving orientation information from an orientation sensor; and selecting a look direction for a beamformer algorithm, wherein the selected beamformer configuration is a wide-beam beamformer configuration when the orientation sensor indicates the device is in a position indicating use with more than one target audio source. In certain embodiments, the orientation sensor indicates the device is in a position indicating use with more than one audio source when the orientation sensor indicates the device is in a horizontal position. The method may also include the step of adapting the beamformer algorithm based on input received from the orientation sensor. The method may also include the step of applying an adaptive post-filter. The method may also include the step of adapting he adaptive post-filter based on input received from the orientation sensor. The method may also include the step of applying an acoustic echo canceler algorithm. The method may further include the step of modifying the acoustic echo canceler algorithm based on information received from the beamformer. The method may also include applying a data smoothing technique to the orientation information.

In yet another example, the solutions provided herein are embodied in computer readable media including computer-executable instructions for using an orientation sensor to select and control one or more noise suppression algorithms applied to audio content captured from a pair of microphones in a device including an orientation sensor and audio processor, the computer-executable instructions causing a system to perform the steps of: receiving orientation information from an orientation sensor; and selecting a look direction for a beamformer algorithm, wherein the selected beamformer algorithm is a wide-beam beamformer algorithm when the orientation sensor indicates the device is in a position indicating use with more than one audio source. The computer readable media may further cause the system to perform the steps of: adapting the beamformer algorithm based on input received from the orientation sensor; applying an adaptive post-filter; adapting he adaptive post-filter based on input received from the orientation sensor; applying an acoustic echo canceler algorithm; and modifying the acoustic echo canceler algorithm based on information received from the beamformer.

The systems and methods taught herein provide efficient and effective solutions for improving the noise reduction performance of microphone arrays in mobile devices.

Another advantage of the systems and methods provided herein is that the beamformer selection algorithm implemented by the processor may select between directional, narrow beam algorithms and wide beam algorithms based on the orientation information received from the orientation signal.

Additional objects, advantages and novel features of the present subject matter will be set forth in the following description and will be apparent to those having ordinary skill in the art in light of the disclosure provided herein. The objects and advantages of the invention may be realized through the disclosed embodiments, including those particularly identified in the appended claims.

### BRIEF DESCRIPTION OF THE DRAWINGS

The drawings depict one or more implementations of the present subject matter by way of example, not by way of limitation. In the figures, the reference numbers refer to the same or similar elements across the various drawings.

FIG. 1 is a schematic representation of a handheld device that uses an orientation sensor to control the noise suppression algorithms applied to audio content captured from a pair of microphones.

FIG. 2 is a flow chart illustrating a method of using an orientation sensor to control the noise suppression algorithms applied to audio content captured from a pair of microphones.

FIGS. 3a and 3b are schematic representations of examples of beamformer look directions for a dual mic mobile phone positioned in portrait (FIG. 3a) vs. landscape (FIG. 3b) orientations.

FIG. 4 is a block diagram of an example of a two mic fixed beamformer algorithm.

FIG. 5 is a block diagram of an example of a two mic adaptive beamformer algorithm.

### DETAILED DESCRIPTION OF THE INVENTION

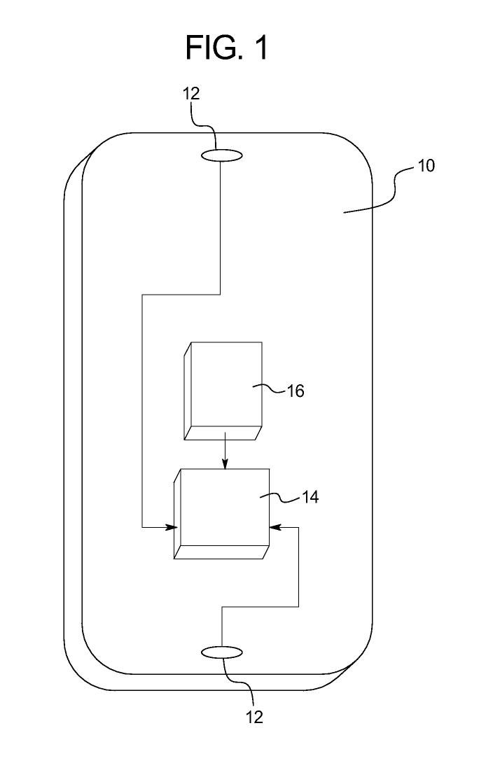

FIG. 1 illustrates a preferred embodiment of a handheld device 10 according to the present invention. As shown in FIG. 1, the device 10 includes two acoustic sensors 12, an audio processor 14, and an orientation sensor 16. In the example shown in FIG. 1, the device 10 is a smartphone, the acoustic sensors 12 are microphones and the orientation sensor 16 is an accelerometer. However, it is understood that the present invention is applicable to numerous types of handheld and/or mobile devices 10, including smartphones, tablets, etc., other types of acoustic sensors 12 may be implemented, and the orientation sensor 16 may be any combination of accelerometers, gyroscopes, compasses, position sensors, etc. It is further contemplated that various embodiments of the device 10 may incorporate a greater number of acoustic sensors 12 and/or various types and numbers of orientation sensors 16.

The audio content captured by the acoustic sensors 12 is provided to the audio processor 14. The audio processor 14 further receives data input from the orientation sensor 16 and uses the data from the orientation sensor 16 to control the noise suppression algorithms applied to audio content, as described further herein. The audio processor 14 may be any type of audio processor, including the sound card and/or audio processing units in typical handheld devices 10. An example of an appropriate audio processor 14 is a general purpose CPU such as those typically found in handheld devices, smartphones, etc. Alternatively, the audio processor 14 may be a dedicated audio processing device.

The orientation sensor 16 in the example shown in FIG. 1 is an accelerometer. However, as noted above, there are numerous types of orientation sensors 16 that may be used in the device 10. Further, the output of multiple types of orientation sensors may be used in combination as input to the audio processor 14. For example, the combination of an accelerometer and a position sensor may be used to supply the audio processor 14 with various forms of orientation data.

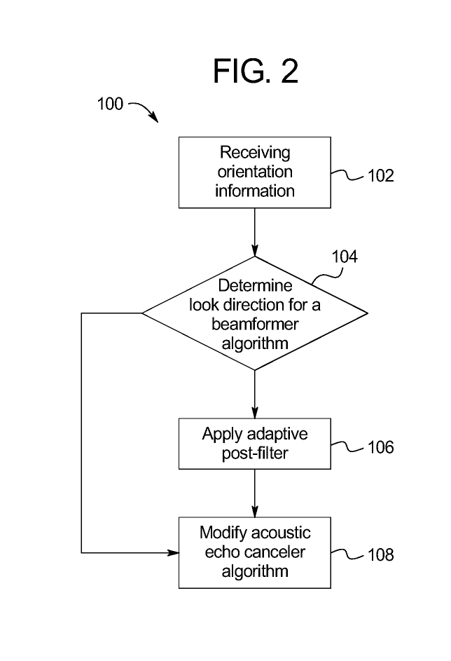

Turning now to FIG. 2, a process flow for using an orientation sensor to control the noise suppression algorithms applied to audio content captured from a pair of microphones 100 is provided (referred to herein as process 100). As shown in FIG. 2, the process 100 includes a first step 102 of receiving orientation information. For example, the audio processor 14 may collect data from the orientation sensor 16 to determine the orientation of the device 10.

The orientation information received in the first step 102 is used to determine a look direction for a beamformer algorithm in a second step 104. For example, the audio processor 14 may use the orientation information provided to select between various directional beamformer configurations (FIG. 2) and a wide-beam configuration. For example, when the mobile device 10 is held upright, a selected directional beamformer may be implemented with the appropriate look direction and, when the device 10 is laid flat on a surface, a wide-beam configuration may be implemented. In one embodiment, one simple choice for a wide-beam configuration is for the beamformer to simply choose one mic channel while discarding other mic channels thereby resulting in an omnidirectional “inclusive” mic response to ensure good voice quality from multiple directions simultaneously.

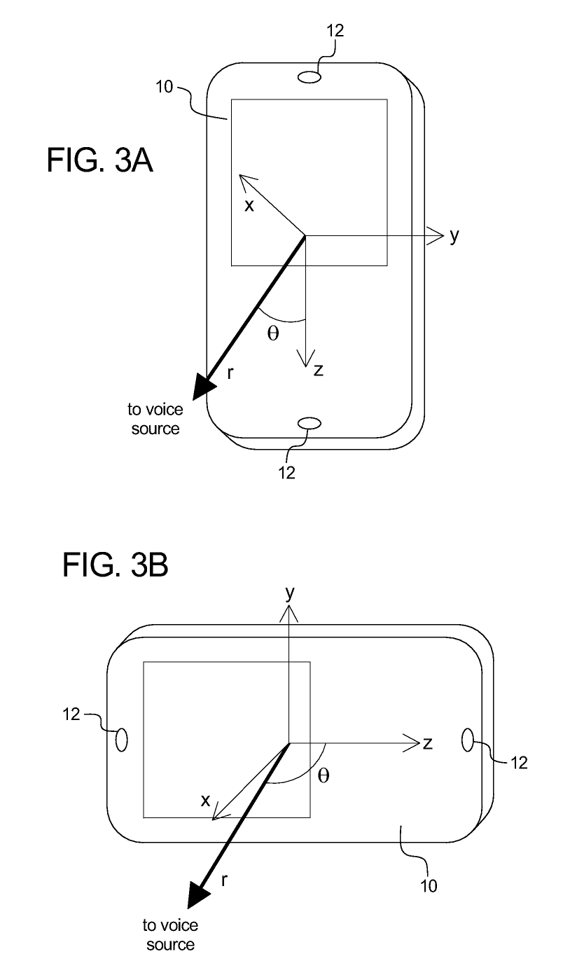

The relationship between device orientation and beamformer look direction is illustrated in FIG. 3. FIG. 3a shows a dual mic mobile phone 10 in portrait orientation. Microphones 12 are located at top and bottom of the handset 10. The optimal beamformer look direction is best determined using spherical co-ordinates with the origin located mid-way between the mics 12 and z-axis corresponding to the inter-mic axis. As shown, for portrait orientation the optimal beamformer look angle θ is >0 and <90 degrees. Therefore, an appropriate preset beamformer look angle for this orientation may be approximately 45 degrees. The exact angle will depend on the device's form factor, mic separation and how the device is being held (e.g., up in front of the user or down in his/her lap). By contrast, FIG. 3b shows the same device 10 in landscape orientation. In this case the optimal beamformer look angle θ is approximately 90 degrees (i.e., r vector lies approximately in the x-y plane).

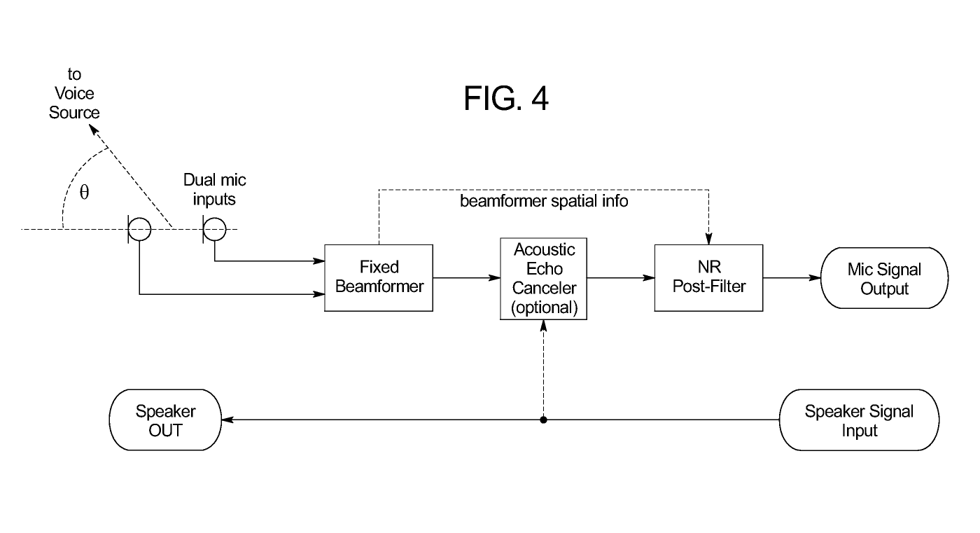

In the example shown in FIG. 4, a fixed beamformer may be implemented. The fixed beamformer may be a delay-sum, filter-sum, or other beamformer algorithm. The fixed look direction is chosen from a set of preset configurations based on the data from the orientation sensor 16.

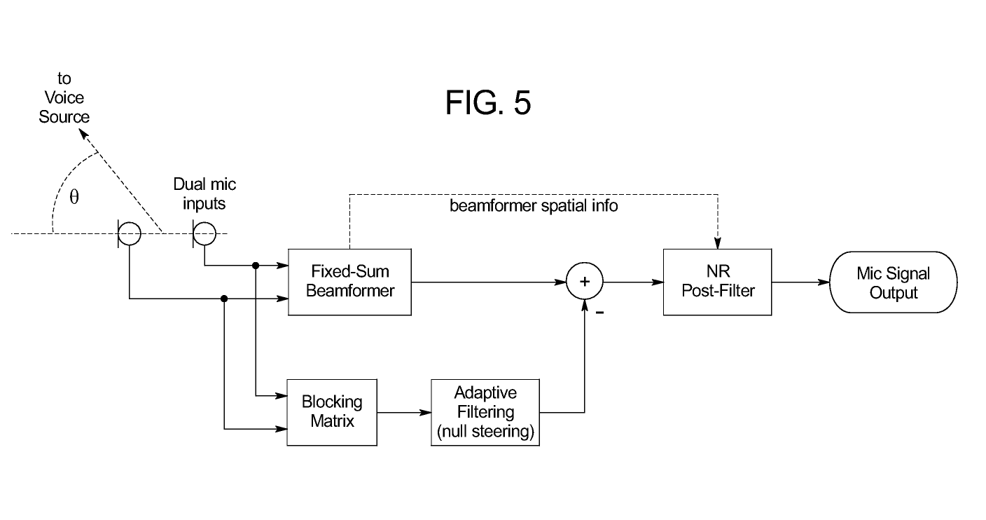

Alternatively, an adaptive beamformer may be implemented. The adaptive beamformer may be, for example, a generalized sidelobe canceller (GSC) as shown in FIG. 5. As with the fixed beamformer, a fixed look direction may be chosen from a set of preset configurations based on data from the orientation sensor 16. However, the beamformer nulls are then adaptively steered to optimally cancel any directional or moving noise sources, for example, using a least mean square (LMS) filter algorithm. The nulls may further be adaptively steered based, at least in part, by passing info received from the orientation sensor 16 to the GSC's adaptive filter and/or blocking matrix (FIG. 5).

Turning back to FIG. 2, as shown in the third step 106, an adaptive post-filter is then applied for additional noise suppression. Traditionally, such post-filter employs both temporal information for tracking stationary noise, as well as inter-microphone spatial information for tracking directional and/or non-stationary noise with a Wiener-type filtering operation. In instances in which spatial information is used in the adaptive post-filter (e.g., inter-mic time delay and/or phase difference analyses), information from the orientation sensor may be used in the adaptive post-filter.

Both the beamformer algorithm and the post-filter algorithms may be implemented in either the time or frequency domain, as appropriate.

In instances in which the device 10 is used for telephony communication, for example in speakerphone, VOIP or video-phone application, multi-microphone noise reduction is usually combined with an acoustic echo canceller (AEC) algorithm to remove speaker-to-microphone feedback. When using a fixed beamformer algorithm, the acoustic echo canceller algorithm is typically implemented after the beamformer to save on processor and memory allocation (if placed before the beamformer algorithm, a separate AEC algorithm is typically implemented for each mic channel). If the beamformer look direction is changed in the second step 104, it would be advantageous for the acoustic echo canceller algorithm to also be adjusted to ensure optimal echo cancellation. Accordingly, as further shown in FIG. 2, in a fourth step 108, if the beamformer's look direction is changed this information is used to modify an acoustic echo canceller algorithm. In one embodiment the AEC algorithm can simply be notified when the beamformer's look direction has been changed and by how much. Since the AEC is located after the beamformer, any change to its configuration may result in an apparent echo path change that the AEC algorithm must re-adapt to. By notifying the AEC algorithm that the apparent echo path has changed by either a little bit or a lot may allow the AEC module to quickly and robustly react to the new beamformer configuration ensuring optimal echo cancellation performance.

Of course, the process 100 shown in FIG. 2 is merely a representative example of a process that may be used to implement the solutions provided by the present subject matter. Any number of alternative processes may be implemented through which the data from the orientation sensor 16 is used by the audio processor 14 to select and control the operation of a noise reduction algorithm applied to audio content captured by the acoustic sensors 12.

The control and adaption noise reduction algorithms by the audio processor 14 may be subject to one or more stabilization algorithms. For example, the audio processor 14 may require a minimum change in orientation angle or may require a minimum duration of orientation shift to invoke a change in the noise reduction algorithm.

While described primarily herein with respect to audio signals captured through two acoustic sensors 12, the teachings of the present subject matter are applicable to audio systems with a greater number of acoustic sensors 12. In addition to selecting a beamformer algorithm, the audio processor 14 may select a specific subset of the acoustic sensors 12 to use to capture the audio content. For example, in certain situations, it may be beneficial to use only a selected subset of the acoustic sensors 12 in order to optimize the quality of the captured audio content, e.g., in some flat tabletop orientations where a wide, inclusive beam is desired it may be advantageous for the beamformer to temporarily use just one mic channel and discard all others to ensure an omnidirectional mic pattern.

It should be noted that various changes and modifications to the presently preferred embodiments described herein will be apparent to those skilled in the art. Such changes and modification may be made without departing from the spirit and scope of the present invention and without diminishing its advantages.

I claim:

1. A handheld device comprising:
an orientation sensor;
an audio processor connected to the orientation sensor and adapted to receive orientation information from the orientation sensor; and
a plurality of acoustic sensors through which audio content is captured, wherein the audio processor selects and applies one or more noise reduction algorithms to the captured audio content based, at least in part, on the orientation information.

2. The device of claim 1 wherein the one or more noise reduction algorithms includes a beamformer algorithm.

3. The device of claim 2 wherein the beamformer algorithm is a fixed beamformer algorithm.

4. The device of claim 2 wherein the beamformer is an adaptive beamformer algorithm.

5. The device of claim 4 wherein the adaptive beamformer algorithm receives, as an input, data from the orientation sensor.

6. The device of claim 2 wherein the beamformer is selected from a group of beamformer configurations including a wide-beam beamformer configuration.

7. The device of claim 2 wherein the one or more noise reduction algorithms further includes an adaptive post-filter.

8. The device of claim 7 wherein the adaptive post-filter receives, as an input, data from the orientation sensor.

9. The device of claim 7 wherein the one or more noise reduction algorithms includes an acoustic echo canceler algorithm.

10. The device of claim 9 wherein the acoustic echo canceler algorithm receives, as an input, data from the beamformer.

11. A method of using an orientation sensor to select and control one or more noise suppression algorithms applied to audio content captured from a pair of microphones in a device including an orientation sensor and audio processor, the method comprising the steps of:
receiving orientation information from an orientation sensor; and
selecting a look direction for a beamformer algorithm, wherein the selected beamformer configuration is a wide-beam beamformer configuration when the orientation sensor indicates the device is in a position indicating use with more than one target audio source.

12. The method of claim 11 wherein the orientation sensor indicates the device is in a position indicating use with more than one audio source when the orientation sensor indicates the device is in a horizontal position.

13. The method of claim 11 further comprising the step of adapting the beamformer algorithm based on input received from the orientation sensor.

14. The method of claim 11 further comprising the step of applying an adaptive post-filter.

15. The method of claim 14 further including the step of adapting he adaptive post-filter based on input received from the orientation sensor.

16. The method of claim 11 further comprising the step of applying an acoustic echo canceler algorithm.

17. The method of claim 16 further comprising the step of modifying the acoustic echo canceler algorithm based on information received from the beamformer.

18. The method of claim 11 wherein a data smoothing technique is applied to the orientation information.

19. Computer readable media including computer-executable instructions for using an orientation sensor to select and control one or more noise suppression algorithms applied to audio content captured from a pair of microphones in a device including an orientation sensor and audio processor, the computer-executable instructions causing a system to perform the steps of:
receiving orientation information from an orientation sensor; and
selecting a look direction for a beamformer algorithm, wherein the selected beamformer algorithm is a wide-beam beamformer algorithm when the orientation sensor indicates the device is in a position indicating use with more than one audio source.

20. The computer readable media of claim 19 further causing the system to perform the steps of:
adapting the beamformer algorithm based on input received from the orientation sensor;
applying an adaptive post-filter;
adapting he adaptive post-filter based on input received from the orientation sensor;
applying an acoustic echo canceler algorithm; and
modifying the acoustic echo canceler algorithm based on information received from the beamformer.
